(19) United States
(12) Patent Application Publication
(10) Pub. No.: US 2008/0183509 A1
(43) Pub. Date: Jul. 31, 2008

(54) System and Method for Assisting a Buyer in Selecting a Supplier of Goods or Services

(76) Inventor: Robert J. Schloss, Briarcliff Manor, NY (US)

Correspondence Address: Whitham, Curtis & Christofferson, P.C.;Suite 340, 11491 Sunset Hills Road, Reston, VA, 20190, US

(21) Appl. No.: 12/061,031

(22) Filed: Apr. 2, 2008

Related U.S. Application Data
(63) Continuation of application No. 10/993,122, filed on Nov. 22, 2004.

(51) Int. Cl. G06Q 40/00

(52) U.S. Cl. 705/4

(57) ABSTRACT

A method for assisting buyers in selecting a supplier of a good or service begins by receiving a price quote for the good or service from the supplier. A request is then submitted to an insurance company requesting the company to issue a policy for reimbursing the buyer for economic damage the buyer may realize as a result of purchasing the good or service from the supplier. The insurance company assesses the risk of insuring the buyer based on information about the buyer and supplier stored in a database. Preferably, the information about the buyer is conveyed electronically to the insurance company over the internet. Also, the risk assessment is preferably all performed in software. A decision on whether to offer the insurance policy to the buyer is then made if a favorable risk assessment is returned. The buyer then decides whether to accept the policy by performing a comparative analysis which involves determining whether the sum of the supplier's costs plus the cost of the insurance policy is greater than or less than the price which the buyer's existing supplier is charging him for the goods or services.

### BACKGROUND OF THE INVENTION

1. Field of the Invention

The present invention generally relates to selecting suppliers of goods or services, and more particularly to a system and method which allows a buyer to make an informed decision in selecting a supplier and for then insuring the buyer against any economic damage which may result from that selection.

2. Background Description

Buyers, both individual and corporate, are faced with the continuing challenge of purchasing goods or services in the most cost-efficient manner possible. In making this decision, there are various trade-offs to consider. Perhaps the most important trade-off involves striking a balance between cost and quality. It is the objective of every buyer to select the supplier who will provide the highest quality goods and services for the cheapest possible price. By making the right selection, buyers can improve their balance sheets and, simultaneously, benefit the consumer by passing along a lower-cost, higher-quality product into the marketplace.

With the emergence of the internet and an increase in brick-and-mortar businesses in general, the choice of a supplier is perhaps more difficult today than ever before. New suppliers are always entering the market, and existing suppliers are upgrading their businesses either by branching into new areas or improving their current product lines. As a result, a supplier who may once have been regarded as satisfactory for meeting the needs of a particular buyer may no longer prove to be adequate.

The internet has addressed the needs of linking buyers and sellers vis-a-vis so-called business-to-business website applications. B-to-B applications have proven to be a significant step forward in expanding the global market. However, they also magnify long-standing problems which buyers of brick-and-mortar type businesses have had to endure for decades.

One of these problems centers around the unfamiliarity buyers have with the business practices of suppliers and the reliability of their products. This is especially true in the case of a supplier who is remotely located from the buyer or one who has newly entered the market. These remotely located or untested suppliers often claim to have superior products than their competitors and for a lower price. Without any first-hand information, however, buyers have no way of substantiating the validity of their claims. The risk of receiving goods or services that are lower in quality than advertised is thus very real.

And even if the goods or services are of satisfactory quality, production capacity is adequate, and delivery transportation capacity is adequate, the insurer may feel that the new supplier's reputation or practices might result in a boycott being organized against the buyer if it purchases from this supplier, i.e., many additional factors may go into the insurance companies risk analysis. It therefore becomes quickly apparent that the wrong choice of a supplier can negatively impact a buyer's business both in terms of market share and dwindling consumer-confidence in the buyer's brand name.

From the foregoing, it is clear that, presently, buyers have no objective way of selecting suppliers of goods or services that will be the most optimal choice for meeting their particular needs.

### SUMMARY OF THE INVENTION

It is an object of the present invention to provide a system and method which serves as an objective tool for assisting buyers in deciding which of a plurality of suppliers is the best choice for meeting the buyer's specific needs.

It is another object of the present invention to achieve the above object by, first, creating a new form of insurance that would protect buyers (e.g., in the form of a full or partial reimbursement) from economic damage that may result from the buyer's selection and subsequent purchase of goods or services from a supplier. The system and method of the present invention then allows an insurance company to objectively decide whether a particular supplier is suitable for the buyer. The insurance company objectively decides suitability by examining the particular needs of the buyer's business, the products or services offered the supplier, the business practices of the supplier, as well as other information.

The final decision is then passed on to the buyer in various ways, including a decision not to offer an insurance policy in the first place. If a policy is offered, the size of the premium price may be used to convey suitability. For example, a high premium price would convey to the buyer that there is a high risk associated with buying from the supplier. Conversely, a relatively low premium price would convey that there is a low risk.

It is another object of the present invention to embody the insurance company's decision-making process in software, and more preferably to convey information between the buyer and insurance company in machine-readable form via the internet, for example, through an interactive website.

It is another object of the present invention to allow the buyer to make the final decision of selecting a supplier based on the insurance company's recommendation, specifically by computing an effective price (derived, for example, by adding the supplier's cost for the requested goods or services and the premium price of the insurance policy) and then comparing this effective price with the price charged by at least one other supplier of the goods or services. The one other supplier may be an existing supplier of the buyer.

These and other objects of the invention are realized by creating a new class of insurance so that if any problems arise as a result of the award of the supply contract, the buying company receives money from the insurance company which it can use to address or resolve the problems. This, in turn, motivates suppliers to document their capabilities to the insurance companies in order to achieve a low-risk insurance rating, and further to allow dynamic procurement systems to operate at the buying company.

Using a dynamic procurement system, the buying company may add a “per-unit insurance cost” to a “cheaper-supplier unit cost” to compute an “effective unit cost.” If this effective unit cost is less than the price of an existing supplier, the buyer may choose to order from the new supplier with the added confidence that the order would be at least partially protected by the insurance policy issued by the insurance company. If the effective unit cost is more than the price of an existing supplier, or of the insurance policy is not offered in the first place, the system and method of the present invention advantageously provides the buyer with an objective basis from which to conclude that the new supplier is unacceptable.

Preferably, this solution offered by the present invention relies on the ability of the procurement and insurance systems to use machine-readable descriptions of what the buying company's product or service is, who their market is, what their reliability must be, and how crucial the component or service from the supplier is. These machine-readable descriptions are digitally transmitted to the insurance company, where software in conjunction with risk analysis can develop an insurance price. The price may be optimally chosen by the insurance company because it has visibility (data sources) to all (or much of) the business this supplier is doing with other buying companies, its track record (performance history as well as recent process changes), as well as a view of the entire portfolio of insurance that has been written.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart showing information flow between a buyer, an insurer, and one or more suppliers in accordance with an embodiment of the present invention;

FIG. 2 is a flow chart showing how a buyer interacts with an insurer in accordance with an embodiment of the present invention;

FIG. 3 is a flow chart showing how an insurer decides whether to offer an insurance policy to a buyer in accordance with the present invention;

FIG. 4 is a flow chart showing the insurer's experience follow-up in accordance with the present invention; and

FIG. 5 is a flow chart showing the supplier submission of data to improve a rating given by an insurance company in accordance with the present invention.

FIG. 6 is a flow chart showing the buyer's evaluation of many suppliers against a previous and usual supplier, or an evaluation of many suppliers for a first time use of the product or service.

### DETAILED DESCRIPTION OF A PREFERRED EMBODIMENT OF THE INVENTION

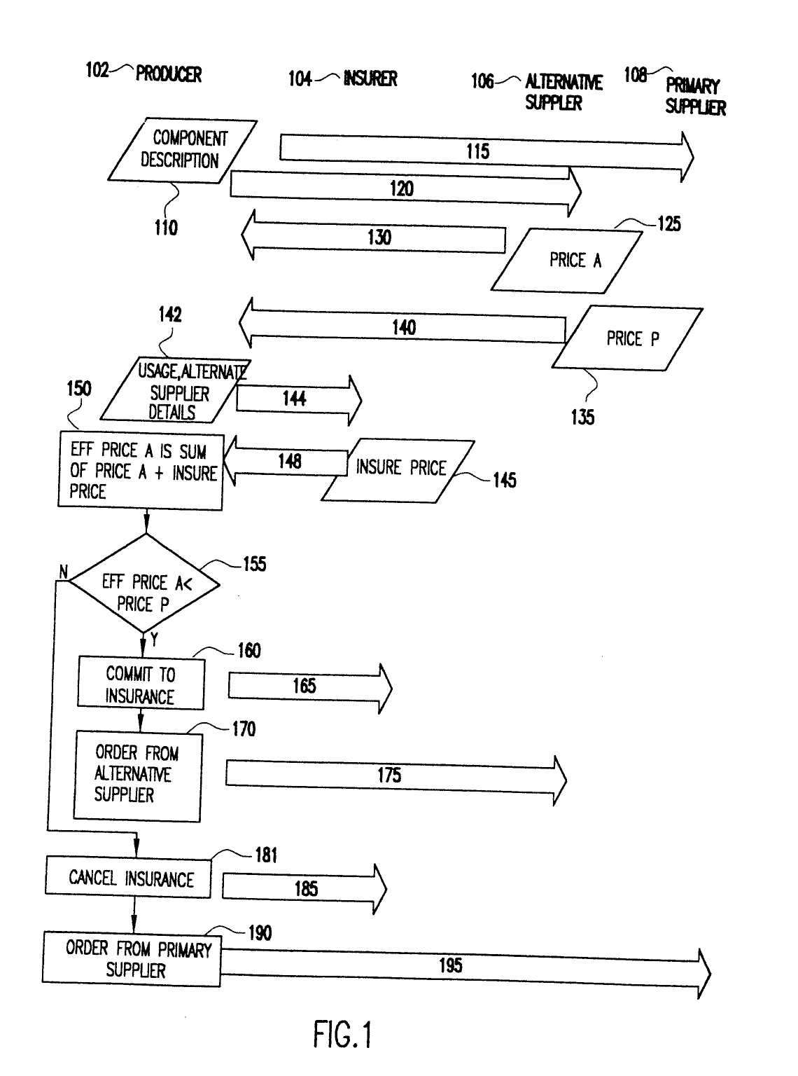

Referring now to the drawings, and more particularly to FIG. 1, there is shown a flow chart of information flow between a buyer 102 (e.g., a producer or manufacturer) and primary and alternative suppliers of goods or services. As will be discussed in greater detail below, this information flow may take place over a network such as the internet. As shown in the chart, the method begins with a producer 102 communicating a request for proposal (RFP) 115 to a first supplier, who may be a primary or trusted supplier 108, and an RFP 120 to at least one alternative supplier 106, who may be a new supplier either to the market or to the buyer. If desired, alternative supplier 106 may be a supplier which has been in the market for some time. From these initial steps alone, it therefore is apparent that the invention provides a useful tool for assisting buyers in selecting the optimal supplier, irrespective of whether the buyers are new to the market although its application to new suppliers is preferable.

Returning to the flow chart, alternative supplier 106 responds at 130 with a price 125, shown as Price A. Likewise, the primary supplier 108 responds at 140 with a price 135, shown as Price P. The producer generates at 142 usage and alternate supplier information 142 which are communicated at 144 to the insurer 104 in the form of a request for quote (RFQ) for insurance. The insurer 104 may or may not respond with a price for insurance 146 which is communicated at 148 to the producer 102. The producer 102 computes in function block 150 an effective price as Price A plus the insurance price. A determination is made by the producer in decision block 155 as to whether the effective price is less than Price P from the primary supplier. If so, the producer 102 commits to the insurance in function block 160 and communicates this to the insurer 104 at 165. The producer then orders from the alternative supplier 106 in function block 170 by communicating the order at 175.

If, however, the effective price is not less than Price P as determined in decision block 155, the insurance is canceled in function block 181, this cancellation being communicated to the insurer 104 at 185. An order from the primary supplier is placed in function block 190 and communicated to the primary supplier 108 at 195. If a current supplier is used, not only would the insurance not be available, optionally there would not even be an opportunity to obtain an evaluation from the insurance company.

The invention computes an effective, or hedged, price for the buying company or producer 102. It leverages the ability of the insurance company 104 to quantify risk and to tap data related to the history of the new supplier 108 with other companies, or a primary (trusted) supplier 108. The invention grows the insurance marketplace in a dramatically new direction. It leads to cheaper costs for buying companies by leveraging the ability of insurance companies to have numerically intensive economic simulations which allow a far more accurate prediction of what the risk exposure actually is.

The basic steps are:

a) The buyer computes “component requirements and potential supplier insurance request for quotation (RFQ)” data structure. This uniquely identifies the buyer, the supplier, the component or service, the products and services it will be used in, who buys those products and services, what the concerns are if they experience functional failure, inadequate supply, whether a failure in this component can be replaced in the field or whether it would require replacing the entire buyer-produced item, how quickly a failure must be fixed based on the users of the buyer-produced item, etc. (One of these for each supplier may be prepared.)

b) The buyer sends “component requirements and potential supplier insurance RFQ” to one (or more) insurance companies.

c) The insurance company consults a database concerning the component or service, supplier, buyer, market and retrieves parameters. In case of insufficient data in the database, the insurance company investigates the supplier.

d) Parameters are run through an analysis (in software, by human, or a combination) to determine the willingness of the insurance company to carry this policy and pricing.

e) The insurance company computer returns “will not carry” or “cost for insurance” to the buyer's procurement system.

f) The buyer's procurement system computes “effective price when bought from this supplier”.

g) The buyer then compares the “effective price” among multiple suppliers to choose from whom to buy.

h) The insurance company tracks on an ongoing basis who is buying from whom and what the successes and failures are, and maintains this data in its database for use in responding to future quotations.

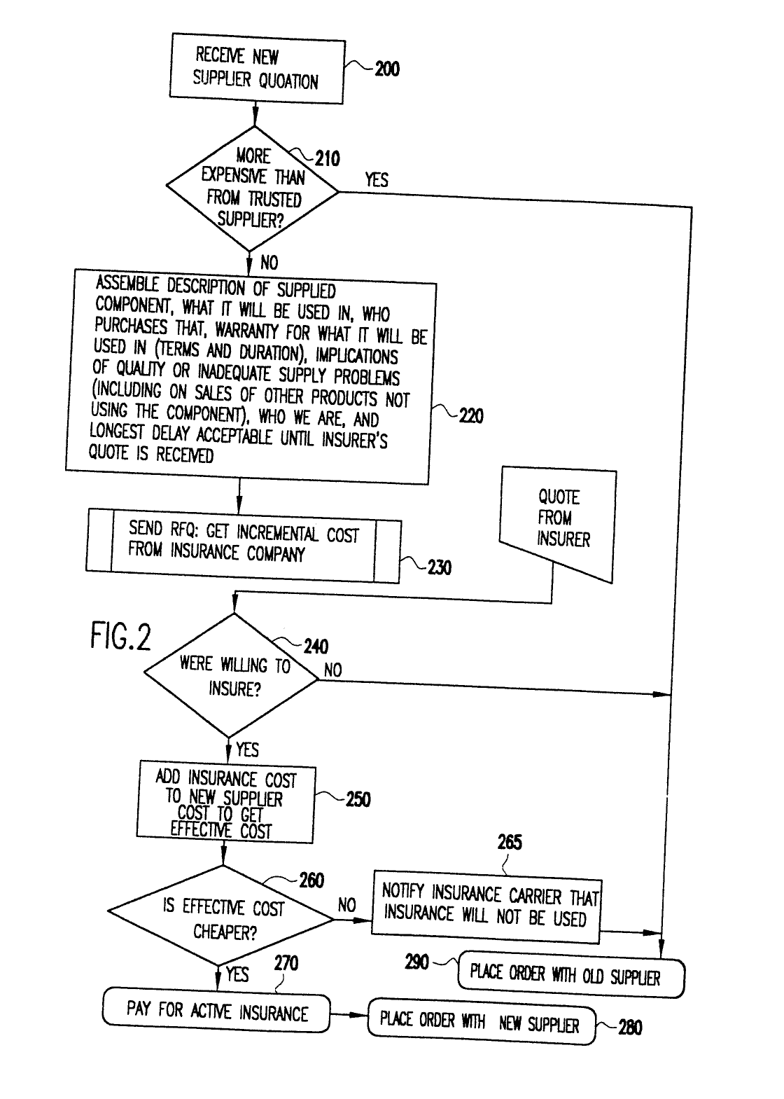

The buying organization's process is illustrated in greater detail in FIG. 2. The process begins at input block 200 when a new supplier quotation is received. A determination is made in decision block 210 as to whether the quotation is more expensive than from a trusted supplier. If so, the order is placed with the trusted supplier in output block 290. However, if the quotation is less expensive than from the trusted supplier, a description of the supplied component is generated in function block 220. This description includes what the component will be used in, who purchases the component, the warranty for what the component will be used in (including terms and duration), implications of quality or inadequate supply problems (including on sales of other products not using the component), and the longest delay acceptable until the insurer's quote is received. With this description in hand, a request for quotation (RFQ) is sent to the insurance company in function block 230.

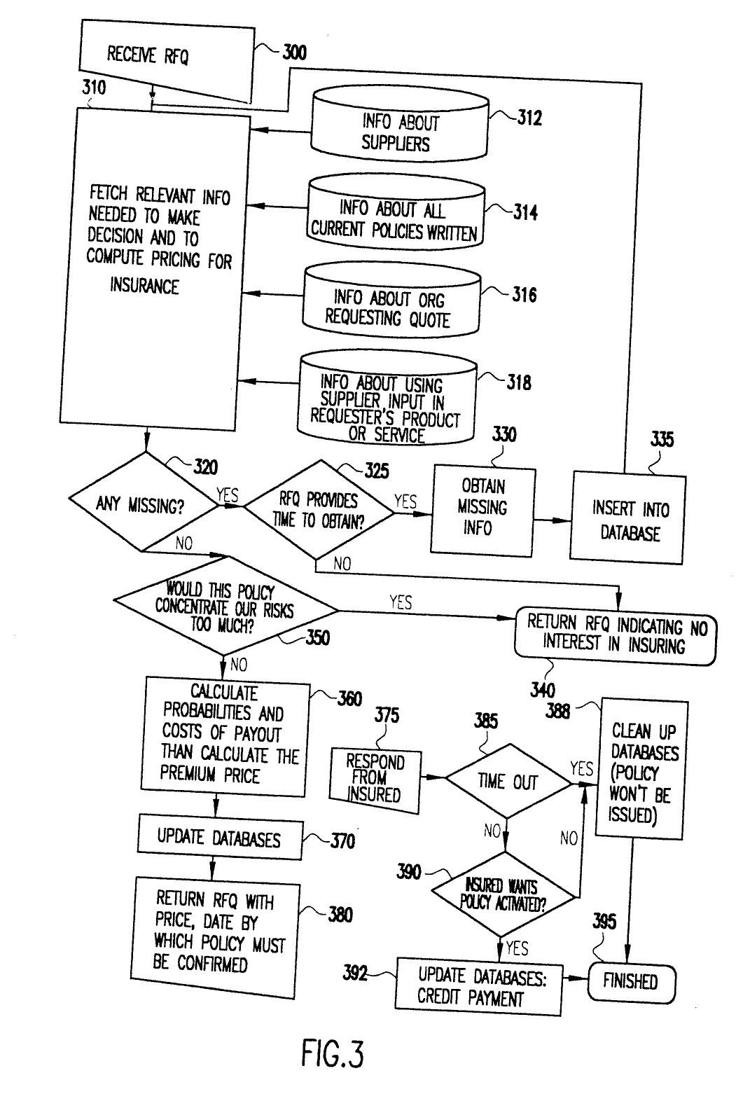

FIG. 3 shows the insurer's process when the RFQ is received in input block 300. The RFQ is analyzed against relevant information needed to make a decision and to compute pricing for insurance in function block 310. The necessary information is accessed from several databases including a suppliers database 312, a current written policies database 314 (including pending quoted policies (the previous output of step 370 below) and including expected “normal” losses under this policy (see 425)), an organization database (i.e., organizations which request quotes) 316, and a database with information about using the supplier's component or service in the requestor's product 318.

When all the relevant information has been retrieved, a determination is made in decision block 320 as to whether any information is missing that is necessary to respond to the RFQ. If so, a determination is made in decision block 325 as to whether the RFQ provides any time to obtain the necessary information. If it does, the missing information is obtained in function block 320, and the information is inserted into the relevant databases in function block 335. If, however, no time is provided in the RFQ to obtain the missing information, then the RFQ is returned in output block 340 indicating that there is no interest in insuring.

Returning to decision block 320, assuming all information needed to make a decision on insurance has been retrieved, a further decision is made in decision block 350 to determine if this policy would concentrate the risks of the insurer too much. If so, the RFQ is returned indicating no interest insuring in output block 340. Otherwise, probabilities and costs of payout are calculated at 360, and based on this calculation the premium price is calculated in function block 350. The insurers databases are updated in function block 370, and then the RFQ is returned with the premium prices and the date by which the policy must be confirmed in function block 380.

Let sp(policy-id) be the set of sub-producers: each maker of a component, or transporter of a component, which the supplier depends on, and all of those that those sub-producers critically depend on, transitively. Policy-id is the id of the proposed policy, or is the id of an in-force insurance policy that is already underwritten by this insurance carrier. Let component-ids (policy-id, sp) be the set of component types which a subproducer produces which are essential to the supplied item covered by policy-id. These are retrieved from database 316. Let fail(sp, ci) be the forecasted probability that a particular subproducer sp fails to deliver timely and functional subcomponent whose component id is ci. This is retrieved from database 312. Let policy-exposure(policy-id) be the financial payout that might be needed if compensation is due to the buyer from the policy specified by policy-id. This is retrieved from database 314.

Let single-impact-max-limit be a value, chosen by the insurance company, of the maximum financial exposure they are willing to accept that would flow from a failure by one producer or one sub-producer affecting one or more of the policies in force. The decision process with respect to overconcentration 350 has two parts. The first part limits the coverage provided under all policies with the identical seller providing the identical component:

$$exp = {\sum }_{op}^{ } policy - exposure ( op )$$

where op=any in-force-policy where seller is this-seller and supplied-item is this item. If exp>single-impact-max-limit then Do Not Underwrite 340 as it would overconcentrate.

If this first test does not identify overconcentration, then a secondary analysis is performed, looking at subproducers, as described by the following exemplary decision algorithm:

For each subproducer sp involved in the supplied item from the proposed policy

For each component that subproducer sp would supply, call it ci
f=fail(sp, ci)
exp=policy-exposure for the proposed policy
For each other policy already in force, call it op
   If subproducer sp produces component ci for this in-force policy op
      Then exp=exp+policy-exposure (op)
End of For each other policy
If exp*f>single-impact-max-limit
   Then Do Not Underwrite as it would overconcentrate
   End of For each component
End of For each subproducer

This decision algorithm is illustrative, because it assumes that the projected failure for different components from the same or from different subproducers are statistically independent. This is not true in all cases. A more sophisticated implementation would use a richer fail function, which would be a function not just of the subproducer and component id, but also of any other subproducer failures.

Various factors may be taken into consideration in performing the calculation in block 360. For example, if the insurance company knows that the alternative supplier's maximum monthly output is MO units, and the number of units needed by the producer is Y units, and that the supplier already has contracts with other producers to supply X units, the decision to insure, or the price of the insurance, may depend on whether the SLACK is positive (and by how much) or negative, where SLACK=MO−X−Y.

Another factor may be the recognition of dependencies of the producer on one or more suppliers in terms. This factor, for example, may involve the insurer recognizing (based on information from an appropriate database) that the producer is buying a component or service in multiple lots from different suppliers. If the insurer is also able to determine that the different suppliers rely on a common form of transportation infrastructure, then the insurer can in accordance with the present invention recognize that the producer's business would be compromised if that common transportation infrastructure collapses or is otherwise impaired (e.g., through a strike, a disaster which prevents travel over the roadways, through an embargo, etc). In this instance, the insurance company may recommend two suppliers that do not have such a common dependency.

The insurance analysis at block 360 considers a range of possible failures. In this embodiment, we present the equations showing how the economic impact of the possible failures is calculated. It is important to remember that all principles of insurance pricing will apply here. For example, if there is reason to believe that the need for a payout will occur much later than the time that the premium is received from the insured, then the premium can be lower because the premium can be invested and grow before needing to fund any payouts. For another example, the premium offered will cover the proportional share of the insurer's overhead, and their costs of active post-contract involvement, and not simply the funding of any financial renumeration.

Some classes of failures, and how they are quantified, will now be shown:
a) delay in supplying sufficient quantity (where economic damage to buyer is in lost sales)
   Let nbpnd be the Number of Buyers' Products Not Delivered
   Let tpo be the total number of buyers' products ordered
   Let QtySupplied be the total quantity which was supplied by the supplier (could be 0)
   Let QtySubstitute be the total quantity which was obtained of substitute components, presumably from a spot market
   Let ppu be the price/unit of each of the buyers products when sold
   Let nbpwsc be the Number of Buyers Products Delivered Containing More Expensive substitute components
   Let pd be the price differential between the substitute components and the contracted price for components from this supplier
   Let poc be the prices paid by the buyer for all the other components which were bought to be used in the buyers product, which were to complement this particular components
   Let avgAddlProf be the average post-sales profit obtained from each of the buyers products that is purchased and used
   Let edrsqt_{pct} be Economic Damage to the buyer related to supply quantity shortfall when pct percent of the order cannot be delivered
   Let edrsqt be the expected Economic Damage to the buyer related to supply quantity

Then we have:
Pd=Price_{substitue}−Price_{constructed}
MaxSubstitutesWanted=Tpo−Qty_{Supplied}
Qty_{Substitue}<=MaxSubstitutesWanted
Nbpnd=Tpo−Qty_{Supplied}−Qty_{Substitute}
Nbpwsc=Qty_{Substitute}
Edrsqt_{pct}=(nbpnd*ppu)+(nbpdn*poc)+(nbpnd*avgAddlProf)+(nbpwsc*pd)

Note that these equations are illustrative and may be oversimplified. For example, the Price_{substitute} for the first batch of backfilled substitute components may be lower than the Price_{substitute} for later or larger batches of backfilled substitute components. Thus, the term nbpwsc*pd may actually be the summation of subquantities using different price differentials. For conciseness, this is not shown in these equations, but is well-known to those skilled in the arts of quantity procurement.

Let nddist be the non-delivery distribution: a table mapping the percentage of supply that cannot be delivered against the likelihood of this occurring can be constructed. For example:

| % supply not delivered | Forecasted probability (FProb) |
|---|---|
| 1% | 0.0099 |
| 2% | . . . |
| 3% | . . . |
| . . . | . . . |
| 99% | . . . |
| 100% | 0.0001 |

For most manufactured components, the forecasted probability decreases as the percentage of supply not being delivered increases. For some components produced with biological processes (e.g. oranges grown in Florida), this slope may not be observed (e.g. if there is a frost, the entire crop gets ruined; if there is a general strike in the country where the factory exists that produces 50% of their widgets, there will be no widgets from that factory until after the general strike ends.). Note that the forecasted probabilities plus the probability that all of the supply is delivered, must equal 1. This table is illustrative in that the insurance company most probably uses an equation that can specify forecasted probability at any value between 0 and 100, such as 2.5759% of supply was not delivered, and not just at integer percentages. In that case, Edrsqt would be the integral of that equation:

$$Edrsqt = {\sum }_{P = 0 …1}^{ } ( Frob ( p ) * {Edrsqt}_{pci} )$$

b) Damage to the buyer's reputation from functional failures of the supplied component (Edrsff)
Let wc be the warranty charges that the buyer will have to pay per failing product unit.
Let nfp be the number of failed product units, after purchase from the buyer.
Let nac be the number of affected customers.
Let acrc be the affected Customer Retention Costs (such as future discounts, consolation gifts, etc.).
Let aPRcosts be additional Public Relations Costs.
Let edrsff be the expected Economic Damage to the buyer's reputation related to functional failures.

Then,

Edrsff=(nfp*wc)+(nac*acrc)+aPRcosts

Referring back to FIG. 2, when a response is received from the insurance company, a determination is made in decision block 240 as to whether the insurance company is willing to insure. If not, the order is placed with the trusted supplier in output block 290. However, if the insurance company is willing to insure, then the insurance cost is added to the new supplier cost to get the effective cost in function block 250. A test is then made in decision block 260 to determine if the effective cost is still less than from the trusted supplier. If not, the insurance company is notified in function block 265 that the insurance will not be used, and the order is placed with the trusted supplier in output block 290. If, however, the effective cost is less than from the trusted supplier, the insurance is paid for in function block 270, and the order is placed with the new supplier in output block 280.

The responses to the insurance company communicated in function blocks 265 and 270 are received at input block 375 in FIG. 3. However, while waiting for a reply, a determination is made in decision block 385 as to whether the time for responding has expired. This time was set in the date function of output block 380. Assuming first that no response is received within the time period set, the databases are cleaned up reflecting that a policy will not be issued in function block 388, and the process completes in block 395. If a response is received before the time period has expired, a determination is made in decision block 390 as to whether the insured wants the policy activated (function block 270) or not (function block 265). If not, the databases are cleaned up in function block 388; otherwise, the databases are updated and the payment is credited in function block 392.

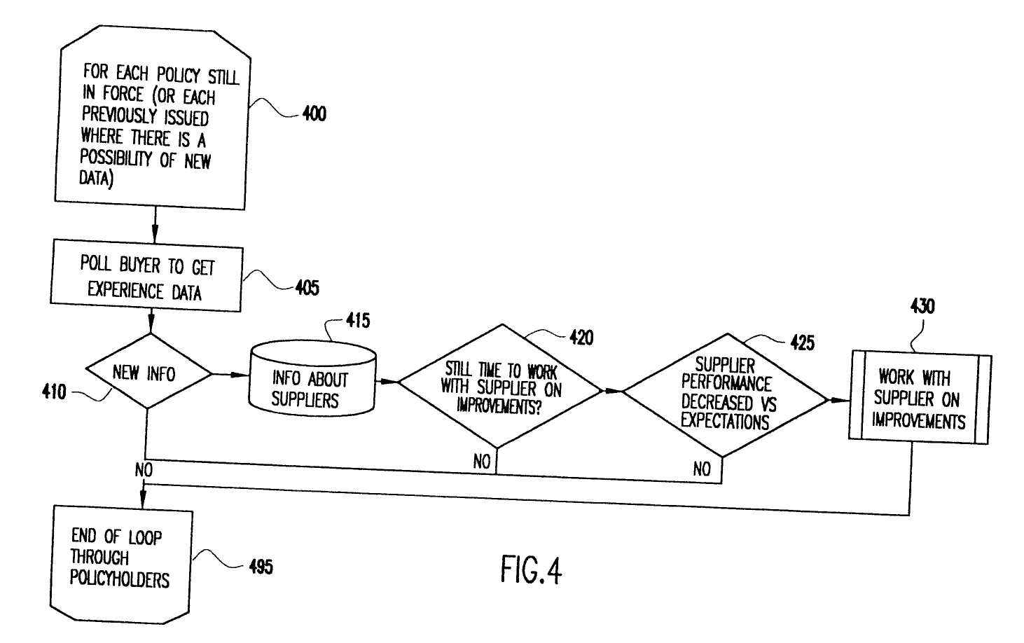

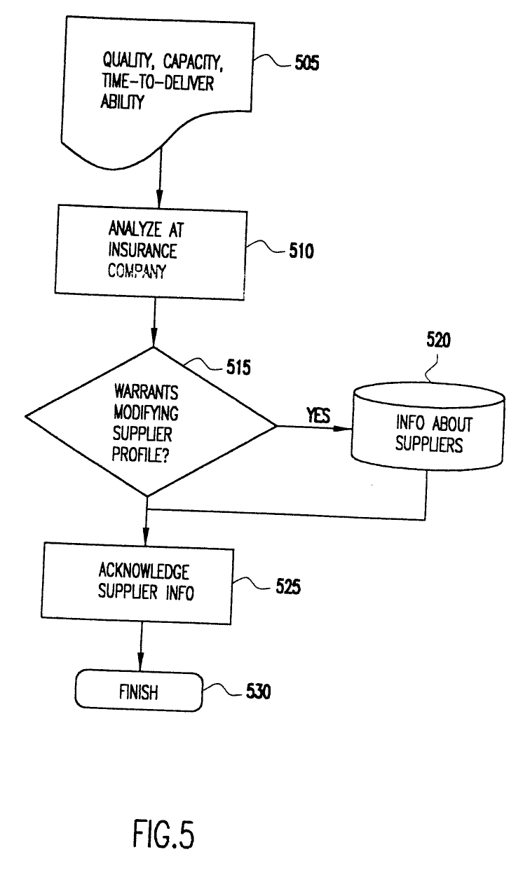

A part of the insurance company procedure is an experience follow-up which is used to update its information database on suppliers. This process is shown in FIG. 4. The follow-up procedure 400 is performed for each policy still in force (or each previously issued where there is a possibility of new data). The buyer is polled in function block 405 to get experience data. The experience data is analyzed in decision block 410 to determine if there is new information on the supplier. If so, the information database on suppliers 415 is updated, and a test is made in decision block 420 to determine if there is still time to work with the supplier on improvements. If so, a further test is made in decision block 425 to determine if supplier performance has decreased versus expectations. If so, the insurer works with the supplier in block 430 to improve the supplier's performance. This feedback process is done until all policies still in force have been processed, as indicated at 495. Since the willingness of an insurer to insure a transaction and the price of the policy makes a difference to the supplier as to whether a supplier receives an order, the supplier may submit data to improve its rating by the insurance company. This process is shown in FIG. 5. The supplier submits information on the quality, capacity and time-to-deliver ability to the insurer in block 505. The insurer analyzes this data in function block 510 and then determines in decision block 515 whether the submitted data warrants modifying the supplier profile. If so, the information database about suppliers 520 is updated. In either case, the data submitted by the supplier is acknowledged in function block 525 before the process finishes at 530.

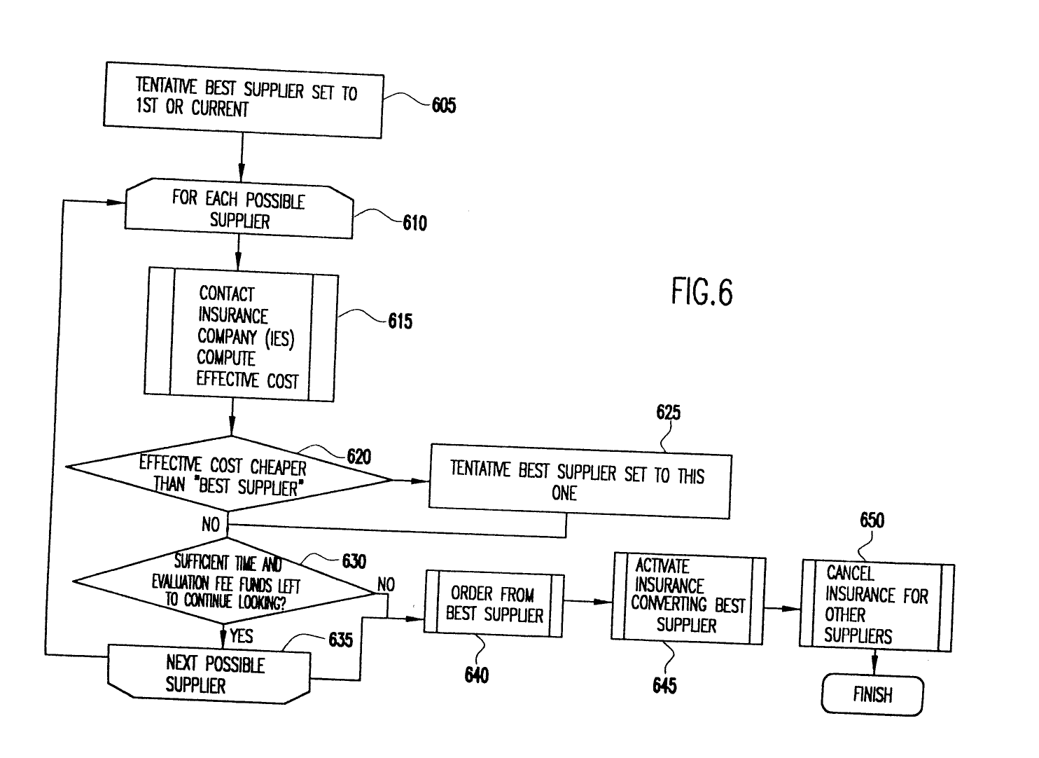

FIG. 6 shows a process which may be performed by the buying organization when multiple alternative suppers are being considered. It could easily occur that two new suppliers quote prices for products which are less expensive than the prices charged by a current (or usual) supplier. It is not necessarily the case that the least expensive quote is the best, because the insurance cost of that supplier might be higher than the insurance cost for a slightly more expensive alternative supplier. Therefore, the buyer may want to get insurance quotes for several suppliers (depending on whether the insurance company changes a fee for providing quotes, and how rapidly multiple quotes can be delivered).

The method of the present invention may provide for this situation by choosing as a tentative best supplier either the supplier which the buyer organization currently buys from or simply the first supplier which returned a quote. (Step 605). For all alternative suppliers (Step 610), the process shown in FIG. 2 (Steps 200 through 260; here shown as Step 615) may be used to determined the effective cost. Next, the method determines whether this supplier is superior to the tentative best supplier. (Step 620). If so, the tentative best supplier is replaced. (Step 625).

If there is sufficient time remaining to obtain additional insurance quotes before production must begin, and if insurance quotes require payment of a fee and the budget for obtaining such quotes has not been exhausted (Step 630), the method continues with the next supplier, if one exists (Step 635).

This process results in one supplier left as the best tentative supplier, and in Step 640, an order is placed with them, the insurance policy for them is activated (Step 645), and any other quotations requested on other suppliers are closed with the insurance company (Step 650).

The economic damage which the present invention is intended to insure against includes not only that which those skilled in the art would generally consider as financial injury to a business, but also any damage that occurs after selection of the supplier including, for example, damage resulting before, during, or at the time of delivery of the goods or services, that resulting from a failure of the goods or services to be as represented and even where the goods or services start failing well after the time of delivery.

Also, the present invention covers the situation where the insurance company never heard of the supplier before the RFQ arrived and needs to investigate before giving a quotation. Therefore, the information need not be in the database to begin with but may work if the information can be input into the database in time for a premium quote to be returned to the buyer during their decision window.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A method for insuring a buyer in the purchase of goods or services, comprising:
(a) receiving a quote request from a buyer, said quote request requesting an insurer to consider reimbursing said buyer for economic damage resulting from said buyer buying goods or services from a seller;
(b) assessing risks of insuring the buyer for reimbursement of said economic damage based on information about said seller, said information including information extracted from information about a plurality of sellers in a plurality of markets for goods and services collected and maintained by said insurer independently from said quote request; and
(c) deciding whether to offer said buyer an insurance policy which at least partially reimburses said buyer for said economic damage based on a risk assessment made in step (b),
wherein computer processes are used to execute at least said receiving and assessing steps.

2. The method of claim 1, further comprising:
transmitting said quote request from said buyer to said insurer over a network.

3. The method of claim 1, wherein said quote request includes information which describes at least two of: i) said goods or services, ii) an intended use by said buyer of said goods or services, iii) a market of said buyer with respect to said goods or services, iv) reliability required of said goods or services by said buyer, and v) an importance of said goods or services to said buyer's business; and
wherein the risk assessment in step (b) is performed based also on said information.

4. The method of claim 3, wherein said information is transmitted by said buyer to said seller in machine-readable form over a network.

5. The method of claim 1, wherein said risk assessment is expressed as a rating which provides an indication of whether insuring said buyer is one of a low risk or a high risk to said insurer.

6. The method of claim 1, wherein if said insurer decides to offer said insurance policy in step (b), said method further comprises:
(d) computing an amount of reimbursement of said buyer based on the risk assessment determined in step (b).

7. The method of claim 1, wherein step (b) includes assessing risk based on one of the following additional forms of information: information about current policies of said insurer, information about organizations which request quotes, and information about using said goods or services of said seller in a business of said buyer.

8. The method of claim 1, further comprising:
maintaining a database of information of said seller;
updating said seller database based on a history of said seller in providing said goods or services; and
performing step (b) based on information in said seller database.

9. The method of claim 1, wherein step (b) includes:
computing a SLACK indicator which includes reducing a maximum monthly output of said goods or services of said supper by an amount of goods or services needed by said buyer and an amount of said goods or services said buyer is obtaining or has contracted to obtain from at least one other seller.

10. The method of claim 1, wherein step (b) includes:
locating a dependency of said buyer on other sellers;
making a recommendation to said seller of reducing reliance of said buyer on said other sellers based on said dependency.

11. The method of claim 1, wherein steps (b) and (c) are performed by a computer program.

12. The method of claim 1, further comprising:
deciding not to extend an offer to said buyer when said insurer is unable to obtain or assess desired information by a predetermined period of time after said quote request was received.

13. The method of claim 1, further comprising:
reimbursing said buyer for economic damage resulting from said buyer buying goods or services from a seller that would not have been sustained had a current supplier been used instead.

14. The method of claim 1, wherein step (b) is performed based on information about said seller stored in one or more databases.

15. A method of obtaining insurance in connection with buying goods or services, comprising:
receiving a price quote from a seller of goods or services;
submitting a request to an insurance company for an insurance policy reimbursing a buyer for economic damage resulting from said buyer buying said goods or services from said seller;
receiving an offer from said insurance company for said insurance policy, said offer including premium information; and
determining whether to accept said offer based on said premium information.

16. The method of claim 15, wherein said seller is a new seller to said buyer with respect to said goods or services.

17. The method of claim 15, wherein said submitting step includes transmitting said request to said insurance company over a network.

18. The method of claim 15, wherein said buyer receives said offer from said insurance company over the internet.

19. The method of claim 15, wherein said determining step includes:
adding said price quote from said seller and price information included in said premium information to derive an effective price for buying said goods or services from said seller;
performing an economic analysis based on said effective price; and
accepting said offer for said insurance policy based on said economic analysis.

20. The method of claim 19, wherein in said adding step adding said price quote and said price information are added on a per-unit cost basis.

21. The method of claim 19, wherein said performing step includes comparing said effective price to a price offered by another seller, and wherein said accepting step includes accepting said offer if said effective price is less than the price offered by said another seller.

22. The method of claim 21, wherein said another seller is a seller previously used by said buyer to buy said goods or services.

23. The method of claim 15, further comprising:
rejecting said offer and choosing to obtain said goods or services from an existing seller.

24. The method of claim 15, further comprising:
communicating a rejection of said offer to said insurance company over a network.

25. The method of claim 15, further comprising:
accepting said offer; and
submitting a request to buy said goods or services to said seller over a network.

26. A method for selecting a seller of a good or service, comprising:
receiving a price quote for said good or service from a seller;
submitting a request for an insurance policy to an insurance company for reimbursing a buyer for economic damage resulting from a purchase of said good or service from said seller, said insurance company maintaining a database of information on said seller;
assessing risk of insuring said buyer with respect to said purchase based at least in part on the information in said database;
offering said insurance policy request upon a favorable risk assessment, said offering step including communicating premium price information for said insurance policy, said premium price information providing an indication of risk to said buyer in purchasing said good or service from said seller.

27. The method of claim 26, further comprising:
comparing a price for said good or service from a previous or existing seller with a price computed by adding said price quote with said premium price information; and
accepting or rejecting said offer of said insurance policy based on said comparing step.

28. The method of claim 26, further comprising:
maintaining, at said insurance company and after acceptance of said insurance policy, a database containing information indicative of an ability of said seller to continue supplying said good or service to said buyer;
conveying information from said database to said buyer; and
determining whether to assist said seller in providing said good or service or discontinue receiving said good or service from said seller based on said conveyed information.

29. The method of claim 26, further comprising:
communicating information relating to said buyer's needs in machine-readable form over a network to said insurance company.

30. A method of linking buyers with sellers, comprising:
providing an insurance company which offers an insurance policy which reimburses a buyer for economic damage resulting from said buyer buying goods or services from a first seller; and
maintaining, at said insurance company, a database which includes a directory of sellers and ratings which said insurance company has assigned to each of said sellers; and
wherein said insurance company further:
(a) selects a second seller from said directory who has a more favorable rating than said first seller; and
(b) contacting either said second seller or said buyer to initiate a supply contract between said buyer and said second seller.

31. A system for insuring a buyer in buying goods or services, comprising:
an insurance company which provides policies that reimburse buyers for economic damage resulting from the purchase of goods or services from sellers;
a database for storing information on a plurality of sellers and their goods or services;
means for assessing a risk of insuring a buyer in purchasing goods or services from a first one of said plurality of sellers; and
means for deciding whether to offer said buyer an insurance policy based on a risk assessment determined by said risk assessing means.

32. An insurance based method for adding to a market for goods or services the price of risk to the buyer of non-performance by a seller, comprising the steps of:
gathering information about each of one or more sellers in said market, said information being extracted from databases of information about sellers in a plurality of markets;
requesting an insurance policy reimbursing a buyer for economic damage resulting from buying goods or services from one of said one or more sellers;
determining a price for said policy, said determination being based on an assessment of risks and an evaluation of said gathered information,
wherein computer processes are used to execute at least said gathering and determining steps.

33. The insurance based method of claim 32, wherein said determined price is combined by said buyer with a price offered by said one of said one or more sellers for said goods or services to produce an effective cost of buying said goods or services from said offering seller.

34. The insurance based method of claim 32, wherein said gathering and determining steps are performed for an insurance company and said requesting step is performed for said buyer, said insurance company providing said buyer with an alternative seller from said one or more sellers if said buyer does not accept said seller's offered price.

35. The method of claim 1, further comprising the steps of:
determining whether any information necessary for assessing risks is missing and obtaining the missing information if said quote provides time to obtain;
evaluating whether an insurance policy issued to said buyer would overly concentrate the risks of said insurer, and deciding not to insure if the policy would overly concentrate the risks; and
calculating probabilities and costs of payout of an insurance policy issued to said buyer, and calculating a premium in response to said quote request, said premium reflecting said probabilities and costs.

36. The method of claim 35, wherein said evaluating step further comprises the step of declining to issue an insurance policy to said buyer for said seller if
$$exp = {\sum }_{op}^{ } policy - exposure ( op ) > single \text{-} impact \text{-} max \text{-} limit$$
where op=any in-force-policy of the insurer where the seller is providing said goods or services and single-impact-max-limit is a value chosen by the insurer, said value being the maximum financial exposure acceptable to the insurer from a failure of the seller.

37. The method of claim 36, wherein said evaluating step further comprises the step of declining to issue an insurance policy to said buyer for said seller if
For each subproducer sp involved in the supplied item from the proposed policy
For each component that subproducer sp would supply, call it ci
f=fail(sp, ci)
exp=policy-exposure for the proposed policy
For each other policy already in force, call it op
If subproducer sp produces component ci for this in-force policy op
Then exp=exp+policy-exposure(op)
End of For each other policy
If exp*f>single-impact-max-limit
Then Do Not Underwrite as it would overconcentrate
End of For each component
End of For each subproducer
where sp(policy-id) is the set of sub-producers: each maker of a component, or transporter of a component, which the seller depends on, and all of those that those sub-producers critically depend on, transitively; Policy-id is the id of the proposed policy, or is the id of an in-force insurance policy that is already underwritten by insurer; component-ids (policy-id, sp) is the set of component types which a subproducer produces which are essential to the supplied item covered by policy-id; fail(sp, ci) is the forecasted probability that a particular subproducer sp fails to deliver timely and functional subcomponent whose component id is ci; and policy-exposure(policy-id) is the financial payout that might be needed if compensation is due to the buyer from the policy specified bypolicy-id.

38. The method of claim 35, wherein said step of calculating probabilities and costs of payout further comprises the step of quantifying delay in supplying sufficient quantity.

39. The method of claim 35, wherein said step of calculating probabilities and costs of payout further comprises the step of quantifying damage to reputation of the buyer from functional failures of the product or service supplied by the seller.
